(19) United States
(12) Patent Application Publication
(10) Pub. No.: US 2003/0182539 A1
(43) Pub. Date: Sep. 25, 2003

(54) Storing execution results of mispredicted paths in a superscalar computer processor

(75) Inventors: Steven R. Kunkel, Rochester, MN (US); David J. Lilja, Maplewood, MN (US); Resit Sendag, Minneapolis, MN (US)

Correspondence Address: Robert R. Williams, IBM Corporation, Dept. 917, 3605 Highway 52 North, Rochester, MN, 55901-7829, US

(73) Assignee: International Business Machines Corporation, Armonk, NY

(21) Appl. No.: 10/102,084

(22) Filed: Mar. 20, 2002

(51) Int. Cl. G06F 9/00

(52) U.S. Cl. 712/225; 712/235

(57) ABSTRACT

It has been determined that, in a superscalar computer processor, executing load instructions issued along an incorrectly predicted path of a conditional branch instruction eventually reduces the number of cache misses observed on the correct branch path. Executing these wrong-path loads provides an indirect prefetching effect. If the processor has a small L1 data cache, however, this prefetching pollutes the cache causing an overall slowdown in performance. By storing the execution results of mispredicted paths in memory, such as in a wrong path cache, the pollution is eliminated. A wrong path cache can improve processor performance up to 17% in simulations using a 32 KB data cache. A fully-associative eight-entry wrong path cache in parallel with a 4 KB direct-mapped data cache allows the execution of wrong path loads to produce an average processor speedup of 46%. The wrong path cache also results in 16% better speedup compared to the baseline processor equipped with a victim cache of the same size. Thus, the execution and storage of loads that are known to be from a mispredicted branch path significantly improves the performance of aggressive computer processor designs. This effect is even more important as the disparity between the processor cycle time and the memory speed continues to increase.

### TECHNICAL FIELD

The present invention relates in general to an improved data processor architecture and in particular to storing the results of executing down mispredicted branch paths. The results may be stored in a wrong path cache implemented as a small fully-associative cache in parallel with the L1 data cache within a processor core to buffer the values fetched by the wrong-path loads plus the castouts from the L1 data cache.

### BACKGROUND OF THE INVENTION

From the standpoint of the computer's hardware, most systems operate in fundamentally the same manner. Computer processors actually perform very simple operations quickly, such as arithmetic, logical comparisons, and movement of data from one location to another. What is perceived by the user as a new or improved capability of a computer system, however, may actually be the machine performing the same simple operations at very high speeds. Continuing improvements to computer systems require that these processor systems be made ever faster.

One measurement of the overall speed of a computer system, also called the throughput, is measured as the number of operations performed per unit of time. Conceptually, the simplest of all possible improvements to system speed is to increase the clock speeds of the various components, particularly the clock speed of the processor. So that if everything runs twice as fast but otherwise works in exactly the same manner, the system will perform a given task in half the time. Computer processors which were constructed from discrete components years ago performed significantly faster reducing the size and number of components; eventually the entire processor was packaged as an integrated circuit on a single chip. The reduced size made it possible to increase the clock speed of the processor, and accordingly increase system speed.

Despite the enormous improvement in speed obtained from integrated circuitry, the demand for ever faster computer systems still exists. Hardware designers have been able to obtain still further improvements in speed by greater integration, by further reducing the size of the circuits, and by other techniques. Designers, however, think that physical size reductions cannot continue indefinitely and there are limits to continually increasing processor clock speeds. Attention has therefore been directed to other approaches for further improvements in overall throughput of the computer system.

Without changing the clock speed, it is still possible to improve system speed by using multiple processors. The modest cost of individual processors packaged on integrated circuit chips has made this practical. The use of slave processors considerably improves system speed by off-loading work from the central processing unit (CPU) to the slave processor. For instance, slave processors routinely execute repetitive and single special purpose programs, such as input/output device communications and control. It is also possible for multiple CPUs to be placed in a single computer system, typically a host-based system which serves multiple users simultaneously. Each of the different CPUs can separately execute a different task on behalf of a different user, thus increasing the overall speed of the system to execute multiple tasks simultaneously.

Coordinating the execution and delivery of results of various functions among multiple CPUs is tricky business; not so much for slave I/O processors because their functions are pre-defined and limited but much more difficult to coordinate functions for multiple CPUs executing general purpose application programs. System designers often do not know the details of the programs in advance. Most application programs follow a single path or flow of steps performed by the processor. While it is sometimes possible to break up this single path into multiple parallel paths, a universal application for doing so is still being researched. Generally, breaking a lengthy task into smaller tasks for parallel processing by multiple processors is done by a software engineer writing code on a case-by-case basis. This ad hoc approach is especially problematic for executing commercial transactions which are not necessarily repetitive or predictable.

Thus, while multiple processors improve overall system performance, it is much more difficult to improve the speed at which a single task, such as an application program, executes. If the CPU clock speed is given, it is possible to further increase the speed of the CPU, i.e., the number of operations executed per second, by increasing the average number of operations executed per clock cycle. A common architecture for high performance, single-chip microprocessors is the reduced instruction set computer (RISC) architecture characterized by a small simplified set of frequently used instructions for rapid execution, those simple operations performed quickly as mentioned earlier. As semiconductor technology has advanced, the goal of RISC architecture has been to develop processors capable of executing one or more instructions on each clock cycle of the machine. Another approach to increase the average number of operations executed per clock cycle is to modify the hardware within the CPU. This throughput measure, clock cycles per instruction, is commonly used to characterize architectures for high performance processors.

Processor architectural concepts pioneered in high performance vector processors and mainframe computers of the 1970s, such as the CDC-6600 and Cray-1, are appearing in RISC microprocessors. Early RISC machines were very simple single-chip processors. As Very Large Scale Integrated (VLSI) technology improves, additional space becomes available on a semiconductor chip. Rather than increase the complexity of a processor architecture, most designers have decided to use the additional space to implement techniques to improve the execution of a single CPU. Two principal techniques utilized are on-chip caches and instruction pipelines. Cache memories store data that is frequently used near the processor and allow instruction execution to continue, in most cases, without waiting the full access time of a main memory. Some improvement has also been demonstrated with multiple execution units with hardware that speculatively looks ahead to find instructions to execute in parallel. Pipeline instruction execution allows subsequent instructions to begin execution before previously issued instructions have finished.

The superscalar processor is an example of a pipeline processor. The performance of a conventional RISC processor can be further increased in the superscalar computer and the Very Long Instruction Word (VLIW) computer, both of which execute more than one instruction in parallel per processor cycle. In these architectures, multiple functional or execution units are connected in parallel to run multiple pipelines. The name implies that these processors are scalar processors capable of executing more than one instruction in each cycle. The elements of superscalar pipelined execution may include an instruction fetch unit to fetch more than one instruction at a time from a cache memory, instruction decoding logic to determine if instructions are independent and can be executed simultaneously, and sufficient execution units to execute several instructions at one time. The execution units may also be pipelined, e.g., floating point adders or multipliers may have a cycle time for each execution stage that matches the cycle times for the fetch and decode stages.

In a superscalar architecture, instructions may be completed in-order and/or out-of-order. In-order completion means no instruction can complete before all instructions dispatched ahead of it have been completed. Out-of-order completion means that an instruction is allowed to complete, speculatively or otherwise, before all instructions ahead of it have been completed, as long as a predefined rules are satisfied. Within a pipelined superscalar processor, instructions are first fetched, decoded and then buffered. Instructions can be dispatched to execution units as resources and operands become available. Additionally, instructions can be fetched and dispatched speculatively based on predictions about branches taken. The result is a pool of instructions in varying stages of execution, none of which have completed by writing final results. These instructions in different stages of interim execution may be stored in a variety of queues used to maintain the in-order appearance of execution. As resources become available and branches are resolved, the instructions are retrieved from their respective queue and “retired” in program order thus preserving the appearance of a machine that executes the instructions in program order.

Several methods have been proposed to exploit more instruction-level parallelism in superscalar processors and to hide the latency of the main memory accesses. These techniques include prefetching data and speculative execution. To achieve high rates of issuance, instructions and data are fetched beyond the basic block-ending conditional branches. These fetched instructions are speculatively executed along the various branches until the branches are resolved. If the prediction was incorrect, the processor state must be restored to the state prior to the predicted branch and execution must be restarted down a different or the correct path. While aggressively issuing multiple wrong path load instructions have a significant impact on cache behavior, it has little impact on the processor's pipeline and control logic. The execution of wrong-path loads, moreover, significantly improves the performance of a processor with very low overhead when there exists a large disparity between the processor cycle time and the memory speed.

A processor with the capability to execute loads from a mispredicted branch path results in continually changing contents of the data cache, although the content of the data registers are not changed. These wrong-path loads access the cache memory system until the branch result is known. After the branch is resolved, the wrong path loads are immediately squashed and the processor state is restored to the state prior to the predicted branch. The execution then is restarted down the correct path. Wrong path loads that are waiting for their effective address to be computed or are waiting for a free port to access the memory before the branch is resolved do not access the cache and have no impact on the memory system. Of course, the speculative execution creates many memory references looking for data and many of these memory references end up being unnecessary because they are issued from the mispredicted branch path. The incorrectly issued memory references increase memory traffic and pollute the data cache with unneeded cache blocks.

Existing processors with deep pipelines and wide instruction issue units capable of issuing more than one instruction at a time do allow memory references to be issued speculatively down wrongly-predicted branch paths. Because these instructions are marked as resulting from a mispredicted branch path when they are issued, they are squashed in the write-back stage of the processor pipeline to prevent them from altering the target register after they access the memory system. In this manner, the processor continues accessing memory with loads that are known to be from the wrong branch path. No store instructions are allowed to alter the memory system, however, because the data fetched from these instructions are known to be invalid, therefore the stores that are known to be down the wrong path after the branch is resolved are not executed eliminating the need for an additional speculative write buffer.

With respect to cache performance, for small direct-mapped data caches, the execution of loads down the incorrectly predicted branch path reduces performance because the cache pollution caused by these wrong-path loads offsets the benefits of their indirect prefetching effect. In order to take advantage of the indirect prefetching effect of the wrong-path loads, we must eliminate the pollution they cause. Executing these loads, however, reduces performance in systems with small data caches and low associativities because of cache pollution occurring when the wrong-path loads move blocks into the data cache that are never needed by the correct execution path. It also is possible for the cache blocks fetched by the wrong-path loads to evict blocks that still are required by the correct path.

There have been several studies examining how this speculative execution affects multiple issue processors. Farkas et al., for example, looked at the relative memory system performance improvement available from techniques such as non-blocking loads, hardware prefetching, and speculative execution, used both individually and in combination. The effect of deep speculative execution on cache performance was studied and differences in cache performance between speculative and non-speculative execution models were examined.

Prefetching can be hardware-based, software-directed, or a combination of both. Software prefetching relies on the compiler to perform static program analysis and to selectively insert prefetch instructions into the executable code. Hardware based prefetching, on the other hand, requires no compiler support, but because it is designed to be transparent to the processor, does require additional hardware connected to the cache.

There have been several hardware-based prefetching schemes proposed in the literature. Smith studied variations on the one block look-ahead prefetching mechanism, such as prefetch-on-miss and tagged prefetch algorithms. The prefetch-on-miss algorithm simply initiates a prefetch for block i+1 whenever an access for block i results in a cache miss. The tagged prefetch algorithm associates a tag bit with every memory block. This bit is used to detect when a block is demand-fetched or a prefetched block is referenced for the first time. In either of these cases, the next sequential block is fetched. Jouppi proposed a similar approach where K prefetched blocks are brought into a first-in first-out (FIFO) stream buffer before being brought into the cache. Because prefetched data are not placed into the cache, this approach avoids the potential cache pollution of prefetching.

Jouppi also proposed victim caching to tolerate the conflict misses in the cache. A victim cache is a small fully-associative cache that holds a few of the most recently replaced blocks, or victims, from the L1 data cache. On a cache read, the L1 and the victim cache are searched at the same time. If the requested address is in the victim cache and not in the L1, the value are swapped and the CPU is forwarded the appropriate data. Victim caching is based on the assumption that the memory address of a cache block is likely to be accessed again in the near future after it has been evicted from the cache resulting from a set conflict.

Several other prefetching schemes have been proposed, such as adaptive sequential prefetching, prefetching with arbitrary strides, and selective prefetching. Pierce and Mudge have proposed a scheme called wrong path instruction prefetching. This mechanism combines next-line prefetching with the prefetching of all instructions that are the targets of branch instructions regardless of the predicted direction of conditional branches, i.e., whenever a branch instruction is encountered at the decode stage, the instructions from both possible branch outcomes are prefetched.

These prefetching schemes, however, require a significant amount of hardware and corresponding logic to implement. For instance, a prefetcher that prefetches the contents of the missed address into the data cache or into an on-chip prefetch buffer may be required, as well as the control logic and/or scheduler to determine the right time to prefetch. Some of the prefetch mechanisms may also incorporate memory history buffers and/or prefetch buffers to further improve the prefetching effectiveness.

### SUMMARY OF THE INVENTION

These needs and others that will become apparent to one skilled in the art are satisfied by a wrong path cache, having a plurality of entries for data fetched for load/store operations of speculatively executed instructions. The entries may include or data cast out by a data cache. Preferably, the wrong path cache has sixteen or fewer entries; and may be a fully-associative cache. Also, the wrong path cache may be in parallel to an L1 data cache. Of course the data within the wrong path cache may be modified, exclusive, shared, or invalid.

The invention may further be considered a method of completing speculatively executed load/store operations in a computer processor, comprising: retrieving a sequence of executable instructions; predicting at least one branch of execution of the sequence of executable instructions; speculatively executing the load/store operations down the at least one predicted branch of execution; requesting data from a data cache for the speculative execution; if the requested data is not in the data cache, requesting data from a wrong path cache; if the requested data is not in the wrong path cache, requesting the data from a memory hierarchy; determining if the at least one predicted branch of execution was speculative; if so, storing the requested data in the wrong path cache; if not, storing the requested data in the data cache.

The method may further comprise executing a next instruction of the sequence of executable instructions; requesting data from the data cache for the next instruction; if the requested data is not in the data cache, requesting data from the wrong path cache; if the requested data is in the wrong path cache, then storing the requested data in the data cache and flushing the wrong path cache of the requested data.

The invention may also be a method of computer processing, comprising: retrieving a sequence of executable instructions; predicting at least one branch of execution of the sequence of executable instructions; executing load operations down all of the at least one branch of execution, and storing the data loaded for all of the at least one branch of execution. The results of the load operations of speculatively executed branches may be stored separate from the result of load operation of the actual executed branch.

The invention may also be broadly considered a method of storing data required by speculative execution within a computer processor, comprising: storing data not determined to be speculative in a normal L1 cache; and storing data determined to be speculative in a wrong path cache.

The invention is also an apparatus to enhance processor efficiency, comprising: means to predict at least one path of a sequence of executable instructions; means to load data required for the at least one predicted path; means to determine if the at least one predicted path is a correct path of execution; and means to store the loaded data for all predicted paths other than the correct path separately from the loaded data for the correct path. There may be additional means to cast out the loaded data for the correct path when no longer required by the correct path in which case the means to store the loaded data for all predicted paths other than the correct path may further includes means to store the cast out data with the loaded data for all predicted paths other than the correct path. Given the above scenario, the invention may also have a means to determine if subsequent instructions of the correct path of execution require the stored data for at least one of the predicted paths other than the then correct path; a means to determine if subsequent instruction of the correct path of execution require data that had been previously cast out; a means to retrieve the stored data for at least one of the predicted paths other than the then correct path; and a means to retrieve the data that had been previously cast out.

The invention is also a computer processing system, comprising: a central processing unit; a semiconductor memory unit attached to said central processing unit; at least one memory drive capable of having removable memory; a keyboard/pointing device controller attached to said central processing unit for attachment to a keyboard and/or a pointing device for a user to interact with said computer processing system; a plurality of adapters connected to said central processing unit to connect to at least one input/output device for purposes of communicating with other computers, networks, peripheral devices, and display devices; a hardware pipelined processor within said central processing unit to process at least one speculative path of execution, said pipelined processor comprising a fetch stage, a decode stage, and a dispatch stage; and at least one wrong path cache to store the results of executing all the speculative paths of execution prior to resolving the correct path. The wrong path cache may further store data cast out by a data cache closest to the processor. The hardware pipelined processor in the central processing unit may be an out-of-order processor.

The invention is best understood with reference the Drawing and the detailed description of the invention which follows.

### BRIEF DESCRIPTION OF THE DRAWING

FIG. 1 is a simplified block diagram of a computer that can be used in accordance with an embodiment of the invention.

FIG. 2 is a simplified block diagram of a computer processing unit having various pipelines, registers, and execution units that can take advantage of the feature of the invention by which results from execution of speculative branches can be stored.

FIG. 3 is a block diagram of a wrong path cache in accordance with an embodiment of the invention.

FIG. 4 is a simplified flow diagram of the process by which a data cache is accessed in a computer processor in accordance with an embodiment of the invention.

FIG. 5 is a simplified flow diagram of the process by which data is written to a wrong path cache in accordance with an embodiment of the invention.

FIG. 6 is a simplified flow diagram of the process by data is read from a wrong path cache in accordance with an embodiment of the invention.

### DETAILED DESCRIPTION OF THE INVENTION

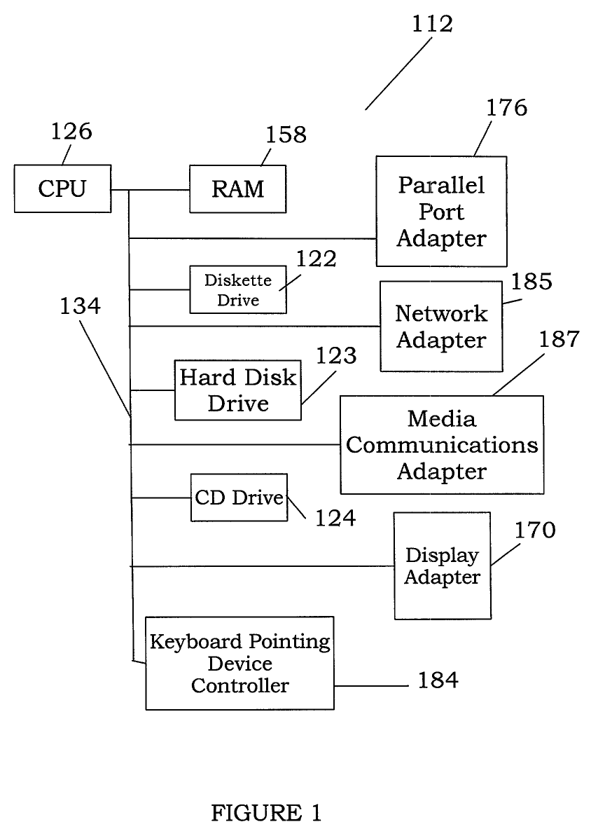

Referring now to the Drawing wherein like numerals refer to the same or similar elements throughout and in particular with reference to FIG. 1, there is depicted a block diagram of the principal components of a processing unit 112. Within the processing unit 112, a central processing unit (CPU) 126 may be connected via system bus 134 to RAM 158, diskette drive 122, hard-disk drive 123, CD drive 124, keyboard/pointing-device controller 184, parallel-port adapter 176, network adapter 185, display adapter 170 and media communications adapter 187. Internal communications bus 134 supports transfer of data, commands and other information between different devices; while shown in simplified form as a single bus, it is typically structured as multiple buses and may be arranged in a hierarchical form.

CPU 126 is a general-purpose programmable processor, executing instructions stored in memory 158. While a single CPU is shown in FIG. 1, it should be understood that computer systems having multiple CPUs are common in servers and can be used in accordance with principles of the invention. Although the other various components of FIG. 1 are drawn as single entities, it is also more common that each consist of a plurality of entities and exist at multiple levels. While any appropriate processor can be utilized for CPU 126, it is preferably a superscalar processor such as from the PowerPC™ line of microprocessors from IBM. Processing unit 112 with CPU 126 may be implemented in a computer, such as an IBM pSeries or an IBM iSeries computer running the AIX, LINUX, or other operating system. CPU 126 accesses data and instructions from and stores data to volatile random access memory (RAM) 158. CPU 126 may be programmed to carry out an embodiment as described in more detail in the flowcharts of the figures; preferably, however, the embodiment is implemented in hardware within the processing unit 112.

Memory 158 is a random-access semiconductor memory (RAM) for storing data and programs; memory is shown conceptually as a single monolithic entity, it being understood that memory is often arranged in a hierarchy of caches and other memory devices. RAM 158 typically comprises a number of individual volatile memory modules that store segments of operating system and application software while power is supplied to processing unit 112. The software segments may be partitioned into one or more virtual memory pages that each contain a uniform number of virtual memory addresses. When the execution of software requires more pages of virtual memory than can be stored within RAM 158, pages that are not currently needed are swapped with the required pages, which are stored within non-volatile storage devices 122, 123, or 124. Data storage 123 and 124 preferably comprise one or more rotating tape, magnetic, or optical drive units, although other types of data storage could be used.

Keyboard/pointing-device controller 184 interfaces processing unit 112 with a keyboard and graphical pointing device. In an alternative embodiment, there may be a separate controller for the keyboard and the graphical pointing device and/or other input devices may be supported, such as microphones, voice response units, etc. Display device adapter 170 translates data from CPU 126 into video, audio, or other signals utilized to drive a display or other output device. Device adapter 170 may support the attachment of a single or multiple terminals, and may be implemented as one or multiple electronic circuit cards or other units.

Processing unit 112 may include network-adapter 185, media communications interface 187, and parallel-port adapter 176, all of which facilitate communication between processing unit 112 and peripheral devices or other data processing systems. Parallel port adapter 176 may transmit printer-control signals to a printer through a parallel port. Network-adapter 185 may connect processing unit 112 to a local area network (LAN). A LAN provides a user of processing unit 112 with a means of electronically communicating information, including software, with a remote computer or a network logical storage device. In addition, a LAN supports distributed processing which enables processing unit 112 to share tasks with other data processing systems linked to the LAN. For example, processing unit 112 may be connected to a local server computer system via a LAN using an Ethernet, Token Ring, or other protocol, the server in turn being connected to the Internet. Media communications interface 187 may comprise a modem connected to a telephone line or other higher bandwidth interfaces through which an Internet access provider or on-line service provider is reached. Media communications interface 187 may interface with cable television, wireless communications, or high bandwidth communications lines and other types of connection. An on-line service may provide software that can be downloaded into processing unit 112 via media communications interface 187. Furthermore, through the media communications interface 187, processing unit 112 can access other sources of software such as a server, electronic mail, or an electronic bulletin board, and the Internet or world wide web.

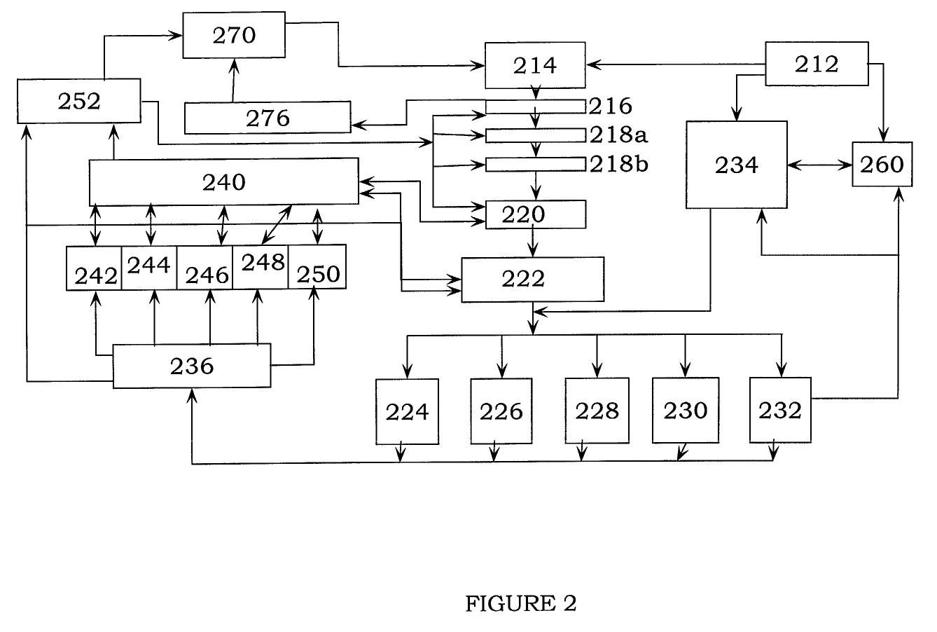

Shown in FIG. 2 is a computer processor architecture 210 in accordance with a preferred implementation of the invention. The processor/memory architecture is an aggressively pipelined processor which may be capable of issuing sixteen instructions per cycle with out-of-order execution, such as that disclosed in System and Method for Dispatching Groups of Instructions, U.S. Ser. No. 09/108,160 filed Jun. 30, 1998; System and Method for Permitting Out-of-Order Execution of Load Instructions, U.S. Ser. No. 09/213,323 filed Dec. 16, 1998; System and Method for Permitting Out-of-Order Execution of Load and Store Instructions, U.S. Ser. No. 09/213,331 filed Dec. 16, 1998; Method and System for Restoring a Processor State Within a Data Processing System in which Instructions are Tracked in Groups, U.S. Ser. No. 09/332,413 filed Jul. 14, 1999; System and Method for Managing the Execution of Instruction Groups Having Multiple Executable Instructions, U.S. Ser. No. 09/434,095 filed Nov. 5, 1999; Selective Flush of Shared and Other Pipelined Stages in a Multithreaded Processor, U.S. Ser. No. 09/564,930 filed May 4, 2000; and Method for Implementing a Variable-Partitioned Queue for Simultaneous Multithreaded Processors, U.S. Ser. No. 09/645,08 filed Aug. 24, 2000, A Shared Resource Queue for Simultaneous Multithreaded Processing, U.S. Ser. No. 09/894,260 filed Jun. 28, 2001; all these patent applications being commonly owned by the assignee herein and which are hereby incorporated by reference in their entireties.

The block diagram of a pipeline processor of FIG. 2 is greatly simplified; indeed, many connections and control lines between the various elements have been omitted for purposes of facilitating understanding. The processor architecture as disclosed in the above incorporated applications preferably supports the speculative execution of instructions. The processor, moreover, preferably, allows as many fetched loads as possible to access the memory system regardless of the predicted direction of conditional branches. Thus, in contrast to existing processors which execute speculative paths, the loads down the mispredicted branch direction are allowed to continue execution even after the branch is resolved, i.e., wrong-path loads that are not ready to be issued before the branch is resolved, either because they are waiting for the effective address calculation or for an available memory port, are issued to the memory system, preferably a wrong path cache, if they become ready after the branch is resolved even though they are known to be from the wrong path. The data resulting from the wrong path loads, however, are squashed before being allowed to write to the destination register. Note that a wrong-path load that is dependent upon another instruction that is flushed after the branch is resolved also is flushed in the same cycle. Wrong-path stores, moreover, are not allowed to execute in this configuration which eliminates the need for an additional speculative write buffer. Stores are squashed as soon as the branch result is known.

The memory hierarchy of the processor as described above may be modified to include a wrong path cache 260 in parallel with a data cache 234. A wrong path cache may be in parallel with the instruction cache 214 but might be less effective than when in parallel with the data cache 234. The data cache 234 may be, for example but not limited to, a non-blocking L1 data cache with a least recently used replacement policy. Instructions for the pipeline are fetched into the instruction cache 214 from a L2 cache or main memory 212. The first level instruction cache 214 may have, for instance, sixty-four kilobytes with two-way set associativity. While the L2 cache and main memory 212 have been simplified as a single unit, in reality they are separated from each by a system bus and there may be intermediate caches between the L2 cache and main memory and/or between the L2 cache and the instruction cache 214. The number of cache levels above the L1 cache levels is not important because the utility of the present invention is not limited to the details of a particular memory arrangement. Address tracking and control to the instruction cache 214 is provided by the instruction fetch address register 270. From the instruction cache 214, the instructions are forwarded to the instruction buffers 216 in which evaluation of predicted branch conditions may occur in conjunction with the branch prediction logic 276.

The decode unit 218 may require multiple cycles to complete its function and accordingly, may have multiple pipelines 218a, 218b, etc. In the decode unit 218, complex instructions may be simplified or represented in a different form for easier processing by subsequent processor pipeline stages. Other events that may occur in the decode unit 218 include the reshuffling or expansion of bits in instruction fields, extraction of information from various fields for, e.g., branch prediction or creating groups of instructions. Some instructions, such as load multiple or store multiple instructions, are very complex and are processed by breaking the instruction into a series of simpler operations or instructions, called microcode, during decode.

From the decode unit 218, instructions are forwarded to the dispatch unit 220. The dispatch unit 220 may receive control signals from the dispatch control 240 in accordance with the referenced applications. At the dispatch unit 220 of the processor pipeline, all resources, queues, and renamed pools are checked to determine if they are available for the instructions within the dispatch unit 220. Different instructions have different requirements and all of those requirements must be met before the instruction is dispatched beyond the dispatch unit 220. The dispatch control 240 and the dispatch unit 220 control the dispatch of microcoded or other complex instructions that have been decoded into a multitude of simpler instructions, as described above. The processor pipeline, in one embodiment, typically will not dispatch in the middle of a microcoded instruction group; the first instruction of the microcode must be dispatched successfully and the subsequent instructions may be dispatched in order.

From the dispatch unit 220, instructions enter the issue queues 222, of which there may be more than one. The issue queues 222 may receive control signals from the completion control logic 236, from the dispatch control 240, and from a combination of various queues which may include, but which are not limited to, a non-renamed register tracking mechanism 242, a load reorder queue (LRQ) 244, a store reorder queue (SRQ) 246, a global completion table (GCT) 248, and a rename pools 250. For tracking purposes, instructions may be tracked singly or in groups in the GCT 248 to maintain the order of instructions. The LRQ 244 and the SRQ 246 may maintain the order of the load and store instructions, respectively, as well as maintaining addresses for the program order. The non-renamed register tracking mechanism 242 may track instructions in such registers as special purpose registers, etc. The instructions are dispatched on yet another machine cycle to the designated execution unit which may be one or more condition register units 224, branch units 226, fixed point units 228, floating point units 230, or load/store units 232 which load and store data from and to the data cache 234 and the wrong path cache 260.

The successful completion of execution of an instruction is forwarded to the completion control logic 236 which may generate and cause recovery and/or flush techniques of the buffers and/or various queues 242 through 250. On the other hand, mispredicted branches or notification of errors which may have occurred in the execution units are forwarded to the completion control logic 236 which may generate and transmit a refetch signal to any of a plurality of queues and registers 242 through 250. Also, in accordance with features of the invention, even after a branch is resolved, execution continues through the mispredicted branch paths and the results are stored the processing unit, preferably in a wrong path cache 260 by the load/store units 232.

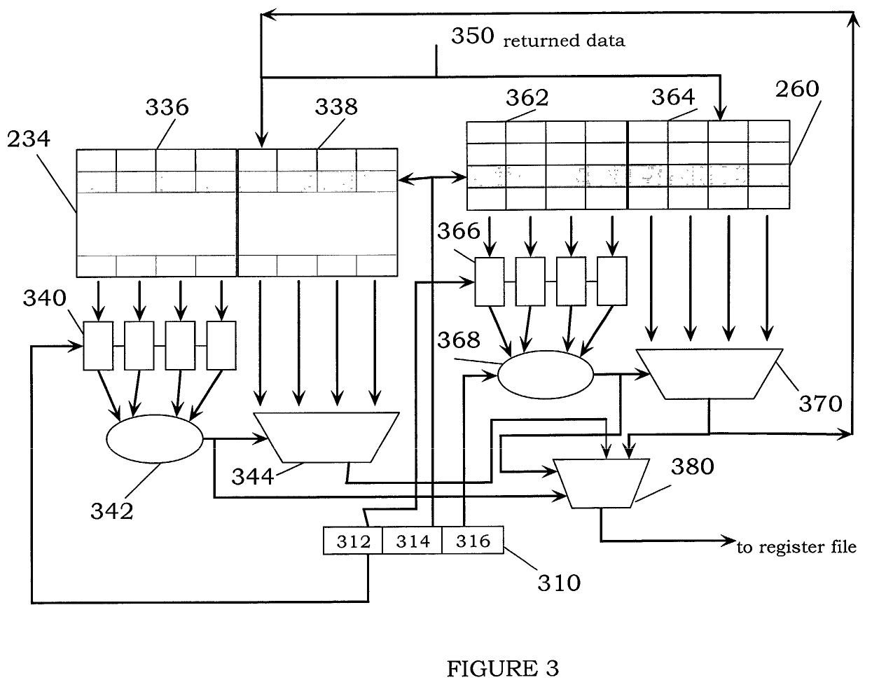

The wrong path cache 260 preferably is a small fully-associative cache that temporarily stores the values fetched by the wrong-path loads and the castouts from the L1 data cache. Executing loads down the wrongly-predicted branch path is a form of indirect prefetching and, absent a wrong path cache, introduces pollution of the data cache closest the processors, typically the L1 data cache. While fully-associative caches are expensive in terms of chip area to build, the small size of this supplemental wrong path cache makes it feasible to implement it on-chip, alongside the main L1 data cache. The access time of the wrong path cache will be comparable to that of the much larger L1 cache. The multiplexer 380 (in FIG. 3) that selects between the wrong path cache and the L1 cache could add a small delay to this access path, although this additional small delay would also occur with a victim cache.

The inventors have observed that the indirect prefetching resulting from memory requests from execution of speculative paths are generally needed later by instructions subsequently issued along the correct execution path. In accordance with the preferred embodiment, the wrong path cache 260 has been implemented to store data loaded as a result of executing a speculative path that ends up being wrong, even after the branch result is known. With respect to FIG. 3, the wrong path cache 260 preferably is a small, preferably four to sixteen entries, fully associative cache that stores the values returned by wrong-path loads and the values cast out from the data cache 234. Note that the loads executed before the branch is resolved are speculatively put in the data cache 234.

Upon execution of a speculative path, both the wrong path cache 260 and the data cache 234 are queried in parallel, as shown in FIG. 3. When an address 310 is requested, the address tag 312 is sent to both the compare blocks 340 and 366 of the data cache 234 and the wrong path cache 260, respectively. Of course, there will be only one match in the compare logic 342 or 368, i.e., either the data is in the wrong path cache 260 or the data is in the data cache 234. Upon a match, the data is muxed 344 or 370 from the data cache 234 or the wrong path cache 260, respectively, through mux 380. If the data is in the wrong path cache 260, the block is transferred simultaneously to both the register files 224-230 of processor and the data cache 234. When the data is neither the data cache nor the wrong path cache, the next cache level in the memory hierarchy is accessed. Upon return 350 of the data from the memory hierarchy, the required cache block is brought into the wrong path cache 260 instead of the data cache 234 to eliminate the pollution in the data cache that could otherwise be caused by the wrong-path loads if the data was loaded because of a wrong path load. Misses resulting from loads on the correct execution path and from loads issued from the wrong path before the branch is resolved are moved into the data cache 234 but not into the wrong path cache 260. The wrong path cache 260 also caches copies of blocks recently evicted by cache misses in that if the data cache 234 casts out a block to make room for a newly referenced block, the evicted block is transferred to the wrong path cache 260.

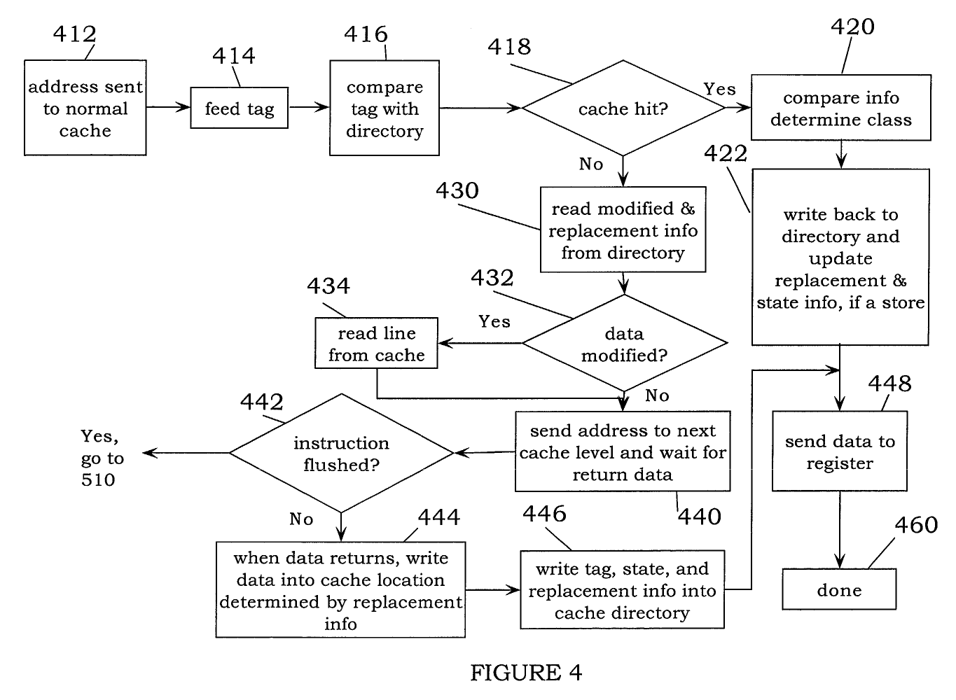

With reference now to FIGS. 3 and 4 together, when the load/store unit sends an address request for data to the data cache 234, as in step 412, the tag 312 of the address 310 is fed to the data cache 234, as in step 414, and the address tag 312 is compared with the tags of the data cache directory, as in step 416. If the data is in the data cache 234, as in step 418, the set information 314 is used in step 420 to determine the congruence class and more. Then in step 422, the address of the data is written back to the cache directory 336 and the replacement information and state of the data is updated. The data is fed to the registers in step 448 and process completes as usual, as in step 460.

If, however, the data is not in the data cache at step 418, then in step 430, the modified and replacement information is read from the directory. If the data has been modified and the old data needs to be castout in step 432, then the line is read from the cache in step 434 and the address and data is sent to the next level in the cache hierarchy in step 440. If the data is not modified in step 432, the address is sent to the next level in the cache hierarchy. In either case, the processor will wait for the correct address and data to be returned in step 440.

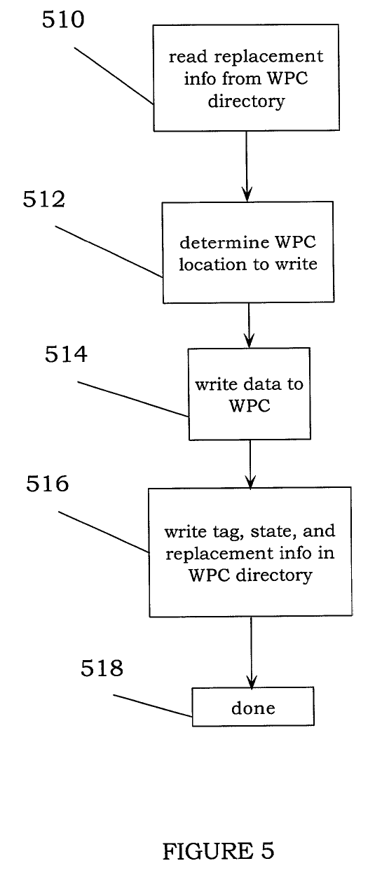

Upon return of the data, an inquiry is made to determine if the instruction is to be flushed in step 442. In a normal data cache 234 without a wrong path cache 260, the data is simply discarded. With a wrong path cache, however, the process is directed to step 510 of FIG. 5.

If, in step 442, the instruction is not flushed, then when the data returns in step 444, the data is written into the data cache 234 at the proper location, and the tag, state, and replacement information is updated in the data cache directory 336 at step 446. The data is then sent to the processor's registers at step 448 and the cache inquiry and data retrieval is completed as in step 460.

FIG. 5 is a simplified flow diagram of how to load the wrong path cache 260 and is consistent with the algorithm below. FIG. 5 starts at step 510 and reads replacement information from the wrong path cache directory 362 in FIG. 3. Because the wrong path cache 260 is a relatively small cache, the replacement scheme may be as simple as First In First Out (FIFO) although other replacement schemes are not precluded. In step 512, the logic 368 of the wrong path cache determines at what location to write the data into the wrong path cache at 364. In step 514, data is written into the wrong path cache 260 and in step 516, the tag directory 362 of the wrong path cache is updated to reflect the tag, the state of the data, and replacement, or other information that may be stored in a cache directory. The process is completed at step 518.

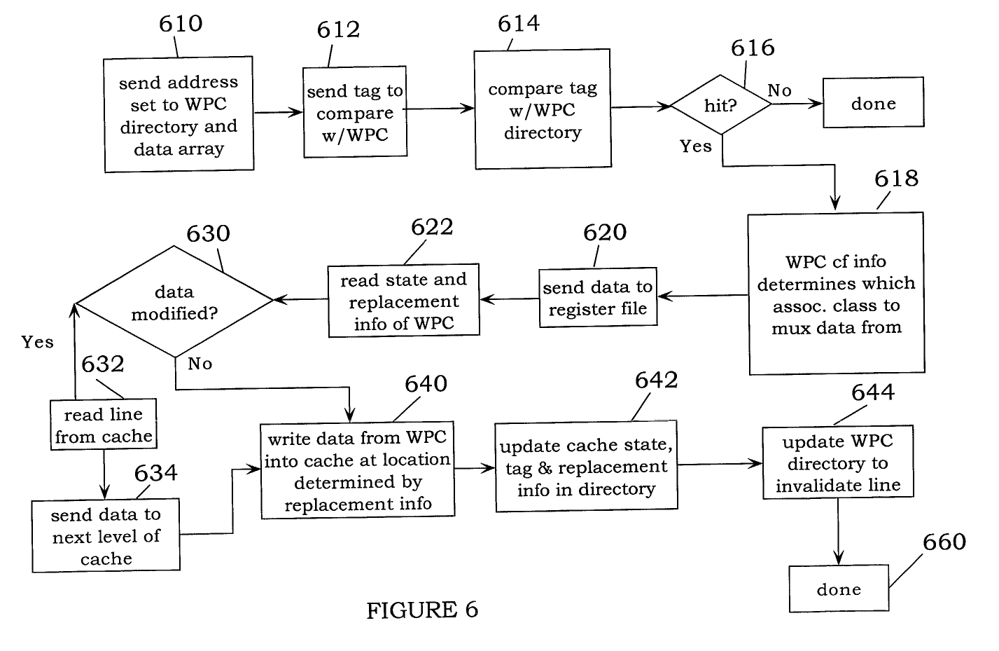

The basic algorithm for accessing the wrong path cache is given in FIG. 6 and the code may be similar to that presented below:.

If (wrong path execution)

If(L1 data cache miss)

| If (Wrong path cache miss) | |
|---|---|
| | Bring the block from the next level memory into the wrong path cache; |
| else | //Wrong path cache hit |

NOP; //Update LRU info for the wrong path cache

| | |
|---|---|
| else | //L1 data cache hit |

| | |
|---|---|
| NOP; | //Update LRU info for the L1 data ache |

| | |
|---|---|
| else | correct path |
| | If(L1 data cache miss) |

If (Wrong path cache miss)

Bring the block from next level memory into L1 data cache

| | Put the victim block into wrong path cache; |
|---|---|
| else | //wrong path cache hit |
| | Swap the victim block and the wrong path cache block; |

| | |
|---|---|
| else | //L1 hit |

| | |
|---|---|
| NOP; | // Update LRU in o or the L1 data cache |

FIG. 6 discloses how data is read from the wrong path cache 260. In steps 610 and 612, the address set and tag is sent to the wrong patch cache directory 362 and comparators 366. The compare function is undertaken at the logic gates 366 of the wrong path cache at step 614 to compare the address tag with the tags stored in the wrong path cache directory 362. If the address tag matches the tag within the wrong path cache directory, as in step 616, there is a cache hit. The process then proceeds to step 618 in which tag information is compared in the comparators at 366 in FIG. 3 to determine from which associativity class the data will be muxed. At step 620, the data from the wrong path cache is sent to the register files of the processor. Step 622 then inquires as to the state and the replacement information of the wrong path cache and asks at step 630 if the data has been modified and needs to be castout from the cache. If so, then at step 632 the data is read from the cache and sent to the next level of cache, for example, a L2 cache, at step 634. In any event, if the data has not been modified and will not be castout, as in step 630, then at step 640, the data from the wrong path cache is written to the data cache 234 at the location determined by the replacement information of the data cache. At step 642, the data cache directory 336 is updated and at step 644, the directory of the wrong path cache 362 is also updated to invalidate the cache line. The process completes then with the valid data stored in the data cache and the line in the wrong path cache having been invalidated.

During simulation, implementation of the wrong path cache as a way of storing the execution results of mispredicted paths has resulted in a processor speedup up to 84% for the ijpeg benchmark compared to a processor without the wrong path cache which discards results from speculative execution. For a parser benchmark, implementation of the wrong path cache gives up to 20% speedup over that of a processor with a victim cache. In general, the smaller the data cache size, the greater the benefit obtained from using the wrong path cache because more cache misses occur from the wrong-path loads compared to configurations with larger caches. These additional misses tend to prefetch data that is put into the wrong path cache for use by subsequently executed correct branch paths. The wrong path cache thus eliminates the pollution in the data cache that would otherwise have occurred without the wrong path cache and utilizes the indirect prefetches.

The wrong path cache produces better performance than a simple victim cache of the same size, for instance, with a four kilobyte direct-mapped data cache, the average speedup obtained from using the wrong path cache is better than that obtained from using only a victim cache. Given a 32 kilobyte direct-mapped data cache, the wrong path cache gives an average speedup of 22% compared to an average speedup of 10% from the victim cache alone. The wrong path cache goes further in preventing pollution misses because of the indirect prefetches caused by executing the wrong-path loads. The wrong path cache also reduces the latency of retrieving data from other levels in the memory hierarchy for both compulsory and capacity misses from loads executed on the correct path. Further, with a data cache of 32 kilobytes with 32-byte blocks, performance improves with increases in the size of the wrong path cache and the victim cache. The use of a wrong path cache, however, improves average speedup greater than ten percent over that of using a victim cache, given sizes of both the wrong path cache and the victim cache of four, eight, and sixteen entries. Even a small wrong path cache produces better performance than a larger victim cache.

Furthermore, the wrong path cache provides greater performance benefit as the memory latency increases. Using a typical memory latency of 60, 100 and 200 cycles for an aggressive processor, the indirect prefetching effect provided by the wrong path cache for loads executed on the correct branch path also increases. The speedup provided by the wrong path cache is up to 55% for the ijpeg benchmark program when the memory latency is 60 cycles; it increases to 68% and 84% when the memory latency is 100 and 200 cycles, respectively. Thus, processor architectures with higher memory latency benefit more from the execution of loads down the wrong path. In a traditional hardware- or software-based prefetching implementation, the target addresses must be fetched as part of the main execution path. But because the prefetched value is needed almost instantaneously by an instruction on this execution path, there often is not enough time to cover the memory latency for the prefetched value. The execution of the wrong-path loads, on the other hand, indirectly prefetches down a path that is not immediately taken. As a result, these wrong-path loads potentially have more time to prefetch a block from memory before the correct path that actually needs the indirectly prefetched values is executed.

Given a branch prediction scheme which has a lower correct branch prediction rate, use of the wrong path cache produces a greater increase in data cache accesses. This can be understood easily because a lower correct branch prediction rate executes more wrong-path loads. And what has been exploited by the inventors is the fact that executing these additional wrong-path loads actually benefits performance because the resulting indirect prefetching effect is higher than the corresponding pollution effect. The wrong-path misses produce indirect prefetches, which subsequently reduce the number of correct-path misses. On the other hand, the cache pollution caused by these wrong-path misses can increase the number of correct-path misses.

When the associativity of the data cache is low, the pollution effect can be greater than the prefetch effect and the performance for small caches can be reduces. A four-way set associative eight kilobyte L1 data cache with a wrong path cache has greater speedup than a processor without the wrong path cache. It has been observed that speedup tends to increase as the associativity of the data cache decreases when the wrong-path loads are allowed to execute. The benefit of the wrong path cache, however, increases for small direct-mapped caches because the pollution effect of the wrong-path loads can overwhelm the positive effect of the indirect prefetches. However, the previous simulations have shown that the addition of the wrong path cache essentially eliminates the pollution effect for direct-mapped caches.

Another important parameter is the cache block size. In general, it is known that as the block size of the data cache increases, the number of conflict misses also tends to increase. Without a wrong path cache, it is also known that smaller cache blocks produce better speedups because larger blocks more often displace useful data in the L1 cache. For systems with a wrong path cache, however, the increasing percentage of conflict misses in the data cache having larger blocks results in an increasing percentage of these misses being hits in the wrong path cache because of the victim caching behavior of the wrong path cache. When the block size is larger, moreover, the indirect prefetches provide a greater benefit because the wrong path cache eliminates cache pollution. Larger cache blocks work well with the wrong path cache given that the strengths and weaknesses of larger blocks and the wrong path cache are complementary.

Thus, while the invention has been described with respect to preferred and alternate embodiments, it is to be understood that the invention is not limited to processors which have only out-of-order processing but is particularly useful in such applications. The invention is intended to be manifested in the following claims.

What is claimed is:

1. A wrong path cache, consisting of: a plurality of entries, each entry including data fetched for load/store operations of speculatively executed instructions.

2. The wrong path cache of claim 1, wherein some of the entries may include or data cast out by a data cache.

3. The wrong path cache of claim 1, wherein the wrong path cache has sixteen or fewer entries.

4. The wrong path cache of claim 1, wherein the wrong path cache is a fully-associative cache.

5. The wrong path cache of claim 1, wherein the wrong path cache has a replacement scheme of first in, first out.

6. The wrong path cache of claim 1, wherein the wrong path cache is in parallel to an L1 data cache.

7. The wrong path cache of claim 1, wherein the data in the wrong path cache may be modified, exclusive, shared, or invalid.

8. A wrong path cache, consisting of: a fully associative cache in parallel with a L1 data cache, the wrong path cache having sixteen or fewer entries, each entry including data fetched for load/store operations of speculatively executed instructions or data cast out by a data cache, the wrong path cache having a replacement scheme of first in, first out.

9. A method of completing speculatively executed load/store operations in a computer processor, comprising:
(a) retrieving a sequence of executable instructions;
(b) predicting at least one branch of execution of the sequence of executable instructions;
(c) speculatively executing the load/store operations down the at least one predicted branch of execution;
(d) requesting data from a data cache for the speculative execution;
(e) if the requested data is not in the data cache, requesting data from a wrong path cache;
(f) if the requested data is not in the wrong path cache, requesting the data from a memory hierarchy;
(g) determining if the at least one predicted branch of execution was speculative;
(h) if so, storing the requested data in the wrong path cache;
(i) if not, storing the requested data in the data cache.

10. The method of completing speculatively executed load/store operations, as in claim 9, further comprising:;
(a) executing a next instruction of the sequence of executable instructions;
(b) requesting data from the data cache for the next instruction;
(c) if the requested data is not in the data cache, requesting data from the wrong path cache;
(d) if the requested data is in the wrong path cache, then storing the requested data in the data cache and flushing the wrong path cache of the requested data.

11. A method of computer processing, comprising:
(a) retrieving a sequence of executable instructions;
(b) predicting at least one branch of execution of the sequence of executable instructions;
(c) executing load operations down all of the at least one branch of execution, and
(d) storing the data loaded for all of the at least one branch of execution.

12. The method of claim 11, wherein a result of the load operations of speculatively executed branches are stored separate from the result of load operation of the actual executed branch.

13. A method of storing data required by speculative execution within a computer processor, comprising:
(a) storing data not determined to be speculative in a normal L1 cache; and
(b) storing data determined to be speculative in a wrong path cache.

14. An apparatus to enhance processor efficiency, comprising:
(a) means to predict at least one path of a sequence of executable instructions;
(b) means to load data required for the at least one predicted path;
(c) means to determine if the at least one predicted path is a correct path of execution;
(d) means to store the loaded data for all predicted paths other than the correct path separately from the loaded data for the correct path.

15. The apparatus of claim 14, further comprising:
(a) means to cast out the loaded data for the correct path when no longer required by the correct path; and
(b) the means store the loaded data for all predicted paths other than the correct path further includes means to store the cast out data with the loaded data for all predicted paths other than the correct path.

16. The apparatus of claim 15, further comprising:
(a) means to determine if subsequent instructions of the correct path of execution require the stored data for at least one of the predicted paths other than the then correct path;
(b) means to determine if subsequent instruction of the correct path of execution require data that had been previously cast out;
(c) means to retrieve the stored data for at least one of the predicted paths other than the then correct path; and
(d) means to retrieve the data that had been previously cast out.

17. A computer processing system, comprising:
(a) a central processing unit;
(b) a semiconductor memory unit attached to said central processing unit;
(c) at least one memory drive capable of having removable memory;
(d) a keyboard/pointing device controller attached to said central processing unit for attachment to a keyboard and/or a pointing device for a user to interact with said computer processing system;
(e) a plurality of adapters connected to said central processing unit to connect to at least one input/output device for purposes of communicating with other computers, networks, peripheral devices, and display devices;
(f) a hardware pipelined processor within said central processing unit to process at least one speculative path of execution, said pipelined processor comprising a fetch stage, a decode stage, and a dispatch stage; and
(g) at least one wrong path cache to store the results of executing all the speculative paths of execution prior to resolving the correct path.

18. The computer processor of claim 16, wherein the wrong path cache further stores data cast out by a data cache closest to the processor.

19. The computer processor of claim 16, wherein the hardware pipelined processor in the central processing unit is an out-of-order processor.
